(19) United States
(12) Patent Application Publication
(10) Pub. No.: US 2010/0063817 A1
(43) Pub. Date: Mar. 11, 2010

(54) ACOUSTIC MODEL REGISTRATION APPARATUS, TALKER RECOGNITION APPARATUS, ACOUSTIC MODEL REGISTRATION METHOD AND ACOUSTIC MODEL REGISTRATION PROCESSING PROGRAM

(75) Inventors: Soichi Toyama, Tsurugashima-shi (JP); Ikuo Fujita, Kawagoe-shi (JP); Yukio Kamoshida, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 12/531,219

(22) PCT Filed: Mar. 14, 2007
(86) PCT No.: PCT/JP2007/055062

§ 371 Date: Nov. 17, 2009

(51) Int. Cl. G10L 15/06

(52) U.S. Cl. 704/243; 704/E15.007

(57) ABSTRACT

An acoustic model registration apparatus, an talker recognition apparatus, an acoustic model registration method and an acoustic model registration processing program, each of which prevents certainly an acoustic model having a low recognition capability for talker from being registered certainly, are provided.

When a talker utters for the N utterances and the utterance sounds of the N utterances are input through the microphone 1, the sound feature quantity extraction part 4 extracts sound feature quantities which indicate the acoustic features of the input utterance sounds, wherein each sound feature quantity has one-to-one correspondence to each utterance, the talker model generation part 5 generates a talker model based on the extracted sound feature quantities for the N utterances, the collation part 6 calculates the degree of individual similarity between the each sound feature quantity of the N utterances and the talker model generated above, and only in the case that all the calculated degrees of similarities of the N utterances are equal to or more than the threshold value, the similarity verifying part 9 directs to register the generated talker model in the talker models' database as a talker model for the talker recognition.

### TECHNICAL FIELD

This application relates to the technical fields of the talker recognition apparatus which recognizes an uttered talker with an acoustic model in which acoustic features of utterance sound uttered by the talker is reflected, the acoustic model registration apparatus by which the acoustic model is registered, the acoustic model registration method and the acoustic model registration processing program.

### BACKGROUND ARTS

Heretofore, talker recognition apparatuses which can recognize the human being (the talker) who emitted a sound has been developed. In such talker recognition apparatuses, when the human being emits the sound of a certain prescribed word or phrase, the talker is recognized by a sound information which is obtained by changing the sound into an electrical signal with the microphone.

Further, when such a talker recognition processing is applied to a user application-type system, a security system or the like, into which the talker recognition apparatus is incorporated, it becomes possible to identify the person himself without requesting hand-inputting of a secret identification code from the person, or to secure the safety of facilities without requiring the locking and opening with a key.

Incidentally, as the talker recognition method of being used for such a talker recognition apparatus includes the methods of doing a talker recognition using the probability models (hereinafter, they are also called “talker recognitions” simply.), such as HMM (Hidden Markov Model), GMM (Gaussian Mixture Model), etc.

In these talker recognitions, first, the person himself repeatedly speaks identical words and phrases at a prescribed times. Then, using the obtained utterance sound as data for learning, the talker is registered (hereinafter, the talker who is registered is called “registered talker”) by modeling the set of spectral patterns which shows the sound feature of the above mentioned data as the acoustic model (hereinafter, it is also simply called a “model”.).

Next, when the talker recognition apparatus is used as a talker recognition apparatus in which the talker who uttered sound is decided among the plural number of registered talkers, the resemblances (likelihoods) between the individual models and the feature of the utterance sound of the talker are calculated respectively, and the registered talker whose model shows the highest degree of the calculated resemblance is recognized as the talker who uttered sound. Alternatively, in the case that the talker recognition apparatus is used as a talker recognition apparatus in which the talker who uttered sound is verified whether he is the registered talker himself or not, when the resemblance (likelihood) between the model and the feature of the utterance sound of the talker is equal to or more than a prescribed threshold value, the verification of the registered talker himself is done.

As described above, on the above-mentioned talker recognitions, since the talker is recognized by comparing the feature of the utterance sound of the talker with the registered model, the important thing is how to construct a model with good quality in order to keep recognition precision in a high level.

However, since there is a case that some noises mix to the voice of the talker depending on the environment when registering a talker, and also there is a case that an utterance beginning part and an utterance ending part can not be correctly specified due to a variation in magnitude of the volume of the utterance sound, the sound section in the utterance sound has come to be sometimes falsely extracted. Further, in the extracted sound section, the noise has come to be sometimes mixed simultaneously with the uttered voice of the talker. In addition, it is considered that the talker would utter a wrong sound for the specified word or phrase at one or a few of the prescribed times of talking the specified word or phrase as required, and the talker would use a varying pronunciation at every time when he talks the specified word or phrase.

When the modeling is performed by using such uttered sounds which belong to those of which the sound section is falsely extracted, in which the noises are mixed, or which features are uneven, a model of which similarities to the features of utterance sounds of the talker are declined are created.

In the Patent Literature 1, a method where sound sections are extracted correctly and the talker recognition is performed certainly has been proposed in consideration of above mentioned circumstances.

Concretely, when registering a talker, first, an input of a keyword by a keyboard or the like is required regarding the keyword which is intended to be told just now by a talker, and a standard recognition model which corresponds to the input keyword is constructed using the HMM. Then, a sound section which corresponds to the keyword is extracted from the utterance sound which is uttered for the first time by the talker in accordance with the word spotting method based on the recognition model. Then, the quantity of features of the extracted sound section is registered in a database as an information for collation and an information for the extraction, and a part of the quantity of features is registered in the database as an information for preliminary retrieval.

Then, regarding the utterance sounds of the second time and later times, a sound section which corresponds to the keyword is extracted from the utterance sound in accordance with the word spotting method based on the information for the extraction, and the similarity is calculated by comparing the quantity of features of the extracted sound section with the information for collation. When the similarity is not more than a threshold value, utterance is required again. When the similarity is equal to or more than a threshold value, the information for collation and the information for preliminary retrieval are updated using the quantity of features of the extracted sound section.

On the identification of the talker, to narrow the registered talkers to talkers who have a high similarity is performed by collating the utterance sound with the information for preliminary retrieval. Then, regarding each of the narrowed talkers, the sound section corresponding to the keyword is extracted using the information for the extraction, and the similarity between the quantity of features of the extracted sound section and the information for collation is calculated. When a similarity which is the largest value among the calculated similarities and which is larger than a threshold value is found, it is determined that the uttered talker is the registered talker who corresponds to the collation model from which the largest degree of the similarity is calculated.

### Patent Literature 1: JP 2004-294755 A

### DISCLOSURE OF THE INVENTION

### Problem to be Solved by the Invention

However, in the method of the Patent Literature 1 mentioned above, there is inconvenience that the talker is obligated to input the keyword by the keyboard or the like before he utters the keyword in order to extract the sound section corresponding to the keyword.

Further, although the similarity between the feature of the utterance sound and the information for collation is verified before the update of the information for collation which is used for the identification of the talker, there is no guarantee that the newest information for collation reflects the feature of the utterance sound of the registered talker sufficiently in the high level, because no verification is not done for the newest information for collation.

Moreover, in order to realize the method described in the Patent Literature 1, it is necessary to make always store both the information for collation and the information for the extraction at least. Thus, a problem that the data amount becomes larger is also raised.

The present invention is contrived by concerning the above-mentioned problems, and one subject thereof is to provide an acoustic model registration apparatus, an talker recognition apparatus, an acoustic model registration method and an acoustic model registration processing program, each of which can prevent certainly an acoustic model having a low recognition capability for talker from being registered.

### Means for Solving the Problem

To solve the above problem, in one aspect of the present invention, the characteristic is to comprise a sound inputting device through which utterance sound uttered by a talker is input; a feature data generation device which generates a feature datum which shows acoustic feature of the utterance sound based on the input utterance sound; a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device; a similarity calculating device which calculates the degree of individual similarity between each feature datum in the prescribed utterance times and the generated acoustic model; and a model memorizing control device which makes a model memorization device memorize the generated acoustic model as a registered model for talker recognition, only in a case where all the degrees of the similarities for the prescribed utterance times are equal to or more than a prescribed degree of the similarity, wherein the degrees of similarities are calculated by the similarity calculating device.

In another aspect of the present invention, the characteristic is to comprise a sound inputting device through which utterance sound uttered by a talker is input; a feature data generation device which generates a feature datum which shows acoustic feature of the utterance sound based on the input utterance sound; a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device; a similarity calculating device which calculates the degree of individual similarity between each feature datum in the prescribed utterance times and the generated acoustic model; a model memorizing control device which makes a model memorization device memorize the generated acoustic model as a registered model for talker recognition, only in a case where all the degrees of the similarities for the prescribed utterance times are equal to or more than a prescribed degree of the similarity, wherein the degrees of similarities are calculated by the similarity calculating device; and a talker determination device which determines whether the uttered talker is a talker corresponding to the registered model or not, by comparing a feature datum with the memorized registered model, wherein the feature datum is generated by the feature data generation device when an utterance sound which is uttered for talker recognition is input through the utterance sound input device.

In a still other aspect of the present invention, regarding an acoustic model registration method using an acoustic model registration apparatus which is equipped with a sound inputting device through which utterance sound uttered by a talker is input, the characteristic is to comprise a feature data generation step in which a feature datum which shows acoustic feature of the utterance sound is generated based on the utterance sound which is input through the sound inputting device; a model generation step in which an acoustic model which indicates acoustic feature of the utterance sound of the talker is generated based on feature data of a prescribed utterance times, wherein the feature data are generated by the feature data generation device in a case where the prescribed utterance times of utterance sounds are input by the sound inputting device; a similarity calculating step in which the degree of individual similarity between each feature datum in the prescribed utterance times and the generated acoustic model is calculated; and a model memorizing control step in which the generated acoustic model is memorized in a model memorization device as a registered model for talker recognition, only in a case where all the degrees of the similarities for the prescribed utterance times are equal to or more than a prescribed degree of the similarity, wherein the degrees of similarities are calculated by the similarity calculating device.

In a further other aspect of the present invention, the characteristic is to make a computer which is installed in an acoustic model registration apparatus, wherein the acoustic model registration apparatus is equipped with a sound inputting device through which utterance sound uttered by a talker is input, function as:

a sound inputting device through which utterance sound uttered by a talker is input; a feature data generation device which generates a feature datum which shows acoustic feature of the utterance sound based on the input utterance sound; a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device; a similarity calculating device which calculates the degree of individual similarity between each feature datum in the prescribed utterance times and the generated acoustic model; and a model memorizing control device which makes a model memorization device memorize the generated acoustic model as a registered model for talker recognition, only in a case where all the degrees of the similarities of the prescribed utterance times are equal to or more than a prescribed degree of the similarity, wherein the degrees of similarities are calculated by the similarity calculating device.

### BRIEF DESCRIPTION OF THE DRAWINGS

FIG. 1 is a block diagram which illustrates an example of the schematic construction of a talker recognition apparatus 100 according to a first embodiment of the present invention.

FIG. 2 is a flow chart which illustrates an example of the flow of a talker registration process of the talker recognition apparatus 100 according to a first embodiment of the present invention.

FIG. 3 is a flow chart which illustrates an example of the flow of a talker registration process of a talker recognition apparatus 100 according to a second embodiment of the present invention.

### EXPLANATION OF NUMERALS

1 Microphone

2 Sound processing part

3 Sound section extraction part

4 Sound feature quantity extraction part

5 Talker model generation part

6 Collation part

7 Switch

8 Model memorization part

### BEST MODE FOR CARRYING OUT THE INVENTION

Now, the preferable embodiments of the present invention will be described in detail with referring to the to the drawings. Incidentally, the embodiments described below are the embodiments where the present invention is applied to talker recognition apparatuses.

### 1. First Embodiment

### [1.1 Constitution and Function of Talker Recognition Apparatus]

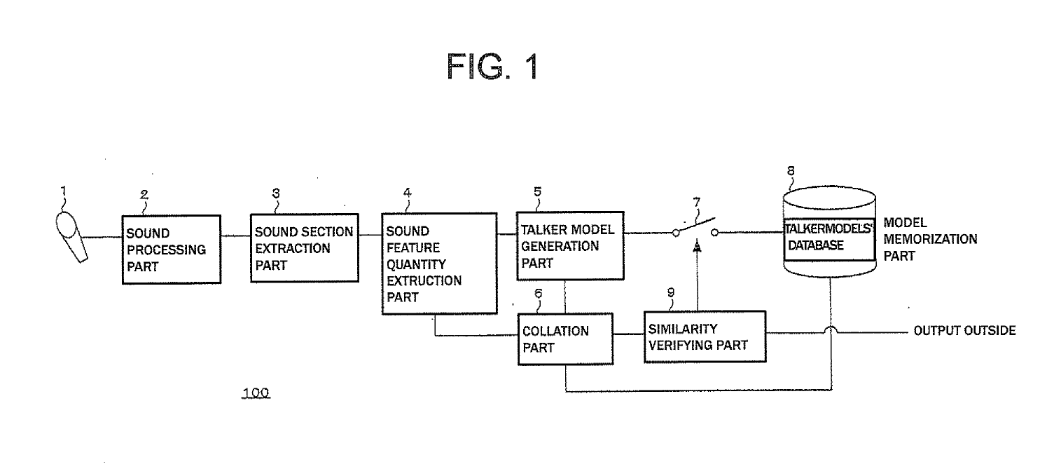

First, the constitution and function of the talker recognition apparatus 100 according to an first embodiment will be explained using FIG. 1.

FIG. 1 is a block diagram which illustrates an example of the schematic construction of the talker recognition apparatus 100 according to the first embodiment of the present invention.

The talker recognition apparatus 100 is a apparatus which recognizes whether a talker is a previously registered talker (registered talker) or not, based on a voice uttered by the concerned talker.

When registering a talker, the talker recognition apparatus 100 learns utterance sounds uttered by the talker for a prescribed times of utterances (hereinafter, the prescribed times are denoted by “N”.) so as to create a talker model (examples of acoustic model, registration model) which reflects the features of the utterance sounds of the concerned talker.

After that, the talker recognition apparatus 100 processes the talker recognition by comparing the feature of utterance sound uttered by a talker to be recognized with the talker model at the time of the talker recognition.

As shown in FIG. 1, the talker recognition apparatus 100 is comprised of a microphone 1 through which the utterance sound of the talker is input; a sound processing part 2 in which a sound signal output from the microphone 1 undergoes a prescribed sound processing in order to convert it to a digital signal; a sound section extraction part 3 which extracts sound signal of utterance sound section from the sound signal output from the sound processing part 2, and divides it into frames at prescribed time intervals; a sound feature quantity extraction part 4 in which sound feature quantity (an example of feature data) of the sound signal is extracted from each individual frame; a talker model generation part 5 in which a talker model is generated using the sound feature quantities which are output from the sound feature quantity extraction part 4; a collation part 6 in which sound feature quantities which are output from the sound feature quantity extraction part 4 are collated with the talker model which is generated by the talker model generation part 5 in order to calculate the degree of similarity; a switch 7; a model memorization part 8 which memorizes the talker model; and a similarity verifying part 9 in which the degree of similarity calculated by the collation part 6 is verified.

Incidentally, the microphone 1 composes an example of the sound input device according to the present invention, the sound feature quantity extraction part 4 composes an example of feature data generation device according to the present invention, and the talker model generation device 5 composes an example of the model generation device according to the present invention. Further, the collation part 6 composes an example of the similarity calculating device according to the present invention, the model memorization part 8 composes an example of the model memorization device according to the present invention, and the similarity verifying part 9 composes an example of the model memorizing control device according to the present invention. Furthermore, the collation part 6 and the similarity verifying part 9 compose an example of the talker determination device.

In above construction, a sound signal which corresponds to the utterance sound of the talker input through the microphone 1 is input into the sound processing part 2. The sound processing part 2 removes high frequency ingredient of this sound signal, converts the sound signal as an analog signal into a digital signal, and then, outputs the digital signal converted sound signal to the sound section extraction part 3.

The sound section extraction part 3 is designed so that the digital signal converted sound signal is input therein. The sound section extraction part 3 extracts a sound signal which indicates a sound section of the utterance sound part in the input digital signal, divides the extracted sound signal for the sound section into flames at prescribed time intervals, and outputs them to the sound feature quantity extraction part 4. As the extraction method of the sound section at this time, it is possible to use a general extraction method which utilizes a level difference between the background noise and the utterance sound.

The sound feature quantity extraction part 4 is designed so that the sound signals of the division flames are input therein. The sound feature quantity extraction part 4 extracts individual sound feature quantity of each sound signal of the division flame. Concretely, the sound feature quantity extraction part 4 analyzes individual spectrum of each sound signal of divided flame, and calculates individual sound feature quantity of the sound signal (e.g., MFCC (Mel-Frequency Cepstrum Coefficient), LPC (Linear Predictive Coding) cepstrum coefficient, etc.) for each flame.

In addition, the sound feature quantity extraction part 4 can reserve the extracted sound feature quantities of the N utterances temporary at the time when the talker registration is proceeded.

Moreover, on the talker registration, the sound feature quantity extraction part 4 can output the reserved sound feature quantities of the N utterances to the talker model generation part 5 and also to the collation part 6, while it can output a extracted sound feature quantity to the collation part, on the talker recognition.

The talker model generation part 5 is designed so that the sound feature quantities of the N utterances which are output from the sound feature quantity extraction part 4 are input therein. The talker model generation part 5 can generate a talker model, such as HMM or GMM, using the sound feature quantities of the N utterances.

The collation part 6 is designed so that the sound feature quantity of each flame which is output from the sound feature quantity extraction part 4 is input therein. By collating the sound feature quantity of each flame with the talker model, this part can calculate the degree of similarity between the sound feature quantity and the talker model, and then the part can output the calculated degree of similarity to the similarity verifying part 9.

Concretely, on the talker registration, the collation part 6 calculates the degree of individual similarity between each sound feature quantity of the N utterances and the talker model, wherein the sound feature quantities of N utterance are output from the sound feature quantity extraction part 4 and the talker model is generated in the talker model generation part 5. Namely, the collation part calculates, the degree of similarity between the sound feature quantity which corresponds to a first utterance and the talker model, the degree of similarity between the sound feature quantity which corresponds to a second utterance and the talker model, - - - , and the degree of similarity between the sound feature quantity which corresponds to a N time' s utterance, thus, this part calculates the degree of similarity for N times in total.

Further, on the talker recognition, the collation part 6 calculates the degree of individual similarity between a sound feature quantity of one utterance which is output from the sound feature quantity extraction part 4 and each talker model memorized in the model memorization part 8.

For example, as for model memorization part 8, it is composed of a storage apparatus, such as a hard disk drive, and in the concerned model memorization part 8, the talker models' database in which the talker models which are generated in the talker model generation part 5 are registered is constructed. In this talker models' database, the individual talker model is registered under a correlation with a user ID (Identifying Information) which is peculiarly allocated to each registration talker.

The similarity verifying part 9 is designed so that the degree of the similarity which is output from the collation part 6 is input therein. The similarity verifying part 9 can verify the degree of similarity.

Concretely, on the talker registration, the similarity verifying part 9 judges whether the condition that all the degrees of the similarities of the N utterances, which are output from the collation part 6, are equal to or more than a prescribed threshold value (an example of prescribed similarity) is satisfied or not. When all the degrees of the similarities of the N utterances are equal to or more than a prescribed threshold value, the part 9 directs the switch to be ON from OFF, and allows the talker model of interest, which is generated by the talker model generation part 5, to be registered in the talker models' database. At this time, the similarity verifying part 9 allocates a user ID to the talker of instant, and the talker model of interest is registered under the correlation with this user ID in the talker models' database.

On the other hand, when at least one of the degrees of the similarities of the N utterances is less than the prescribed threshold value, the part 9 directs the sound feature quantity extraction part 4 to delete all sound feature quantities of the N utterances which are reserved temporarily in the part 4, and also directs to delete the talker model generated by the talker model generation part 5. Then, the part 9 requires to restart the processes beginning with the inputs of utterance sounds of the N utterances. Namely, until the condition that all the degrees of the similarities of the N utterances are equal to or more than a prescribed threshold value is attained, the inputs of utterance sounds of the N utterances, the extractions of the sound feature quantities for the N utterances, the generation of the talker model, and the collation, are repeated.

On the talker recognition, the similarity verifying part 9 chooses as the recognition talker the registered talker who corresponds to the talker model from which the largest degree of the similarity is calculated among the degrees of the similarities (the similarities corresponding to all talker models registered in the talker models' database) output from the collation part 6. Then, the similarity verifying part 9 outputs the result of the recognition to outside of the apparatus. The output recognition result is, for instance, announced to the talker (for instance, displaying on a screen, outputting voice), used for a control of the security, or the result makes a processing which is adaptable to the recognized talker practice run, by a system into which the talker recognition apparatus 100 is incorporated.

### [1.2 Operation of Talker Recognition Apparatus]

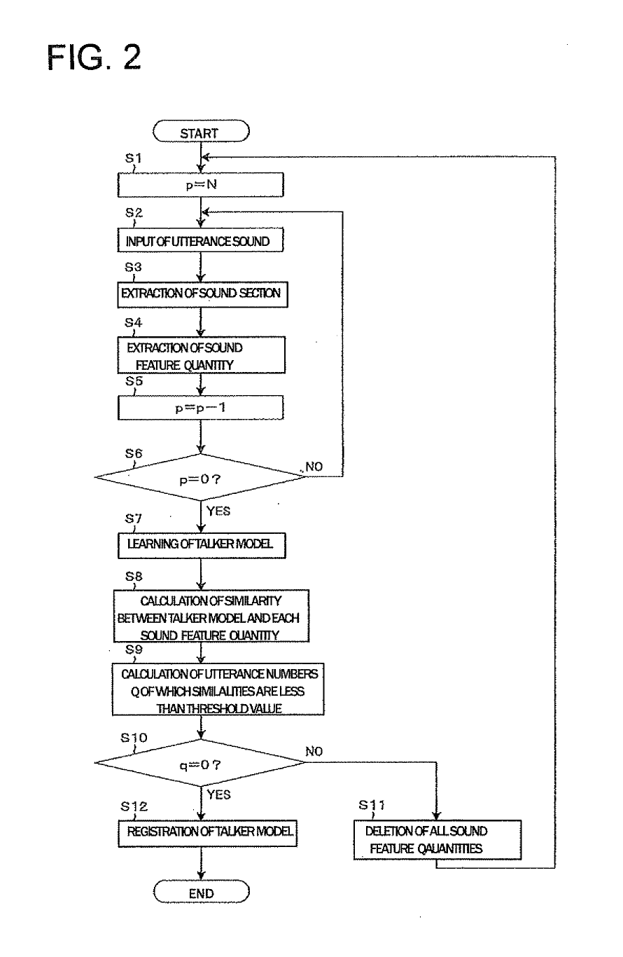

Next, operation of the talker recognition apparatus 100 will be explained using FIG. 2. Incidentally, because the processing on the talker recognition is same with those in the methods known in the prior art, the explanation about this processing is omitted, and only the processing on the talker registration will be explained below.

FIG. 2 is a flow chart which illustrates an example of the flow of a talker registration process of the talker recognition apparatus 100 according to a first embodiment of the present invention.

As shown in FIG. 2, first, the sound feature quantity extraction part 4 substitutes the prescribed utterance number of “N” into a counter p (Step S1).

Next, a sound of one utterance uttered by a talker is input though the microphone 1. When a sound signal corresponding the sound is output (Step S2), the sound processing part 2 converts the sound signal into a digital signal, and the sound section extraction part 3 extracts a sound section and outputs sound signals of being divided into flames (Step 3).

Next, the sound feature quantity extraction part 4 extracts individual sound feature quantity of each sound signal of the division flame, and retains the sound feature quantities (Step 4), and then it directs the counter p to subtracts 1 from the counter's present number (Step 5).

Next, the sound feature quantity extraction part 4 determines whether the counter p is 0 or not (step S6). When the counter p is not 0 (step S6:NO), the operation shifts to Step S2. In other words, until the sound feature quantities of the N utterances are retained, the processing of steps S2-S5 are repeated.

On the other hand, when the counter p is 0 (Step S6:YES), the sound feature quantity extraction part 4 outputs the retained sound feature quantities for the N utterances to the talker model generation part 5 and also to the collation part 6. The talker model generation part 5 performs the model learning using these sound feature quantities, and generates a talker model (Step S7).

Next, the collation part 6 calculates the degree of individual similarity between each sound feature quantity of the N utterances and the talker model (Step S8).

Next, the similarity verifying part 9 calculates the number of the data each of which degree of similarity is less than the threshold value, by making comparison between the degree of each similarity of the N utterances and the threshold value, wherein the calculated number is denoted as criteria-unsatisfied utterance number q (Step S9). Then, the part 9 determines whether the criteria-unsatisfied utterance number q is 0 or not (step S10).

When the criteria-unsatisfied utterance number q is not 0, that is, when at least one of the degree of the similarity among the degrees of the similarities for the N utterances is less than the threshold value (Step S10:NO), the sound feature quantity extraction part 4 deletes all sound feature quantities of the N utterances which are retained in the part 4 (Step S11), and the operation shifts to Step S1. In other words, until all degrees of the similarities of being calculated for the N utterances are equal to or more than a prescribed threshold value, the processing of Steps S1-S9 are repeated. Concretely, when utterance sounds of the N utterances are re-input and an individual sound feature quantity corresponding to each re-input utterance sound is re-extracted, a talker model is re-generated using the re-extracted sound feature quantities of the N utterances, the degree of individual similarity between each re-extracted sound feature quantity of the N utterances and the re-generated talker model is calculated, and a criteria-unsatisfied utterance number q is calculated by making comparison between the degree of each similarity of the N utterances and the threshold value.

On the other hand, when the criteria-unsatisfied utterance number q is 0, that is, when all the calculated degrees of the similarities for the N utterances are equal to or not less than the threshold value (Step S10:YES), the similarity verifying part 9 registers the generated talker model (or re-generated talker model) into the talker models' database, and it is allowed to end the talker registration processing.

As described above, according to this embodiment, when a talker utters for the N utterances and the utterance sounds of the N utterances are input through the microphone 1, the sound feature quantity extraction part 4 extracts sound feature quantities which indicate the acoustic features of the input utterance sounds, wherein each sound feature quantity has one-to-one correspondence to each utterance, the talker model generation part 5 generates a talker model based on the extracted sound feature quantities for the N utterances, the collation part 6 calculates the degree of individual similarity between the each sound feature quantity of the N utterances and the talker model generated above, and only in the case that all the calculated degrees of similarities of the N utterances are equal to or more than the threshold value, the similarity verifying part 9 directs to register the generated talker model in the talker models' database as a talker model for the talker recognition.

When a talker model is generated using certain utterance sounds which features are broadly distributed, for instance, in the case that the sound section is falsely extracted, the case that some noises are mixed, or the case that features of the utterance sounds are uneven, on the whole the similarity between the generated talker model and each feature of utterance sound of the talker goes down. Thus, in this case, it can hardly say that the talker model which adequately reflects the features of the utterance sounds of the talker is produced, and this fact will become a direct cause of the inferior ability to recognize talker.

According to this embodiment, since the taker model is registered only when all the degrees of similarities are equal to or more than the threshold value, it is certainly possible to avoid registering the talker model which brings down the capability of talker recognition.

Further, by setting the threshold value to a appropriate value in advance, it is possible to recognize that a talker utters the same keyword at the N times of utterances without making a mistake, when a result that the all the degrees of similarities between each sound feature quantity of all utterances and the talker model is obtained. Therefore, it is not necessary to request the talker to make a troublesome work such as typing of the keyword before utterance, and also not necessary to use a specialized method for extracting the sound section.

Further, when at least one of the degree of the similarity among the degrees of the similarities for the N utterances is less than the threshold value and then the talker again utters the sounds of the N utterances, the utterance sounds of the N utterances are re-input through the microphone 1, an individual sound feature quantity corresponding to each re-input utterance sound is re-extracted by the sound feature quantity extraction part 4, a talker model is re-generated using the re-extracted sound feature quantities of the N utterances by the talker model generation part 5, the degree of individual similarity between each re-extracted sound feature quantity of the N utterances and the re-generated talker model is re-calculated by the collation part 6, and only in the case that all the re-calculated degrees of similarities of the N utterances are equal to or more than the threshold value, the re-generated talker model is registered in the talker models' database by the similarity verifying part 9. Thus, it is possible to register the talker model only when the features of the utterance sounds for the N utterance become even finely.

### 2. Second Embodiment

Next, a second embodiment will be explained.

When at least one of the calculated degrees of the similarities of the N utterances is less than the prescribed threshold value, all sound feature quantities of the N utterances are deleted and utterance sounds of another N utterances are input according to the above described first embodiment, while, in the second embodiment described below, the number of utterance sounds to be re-input is only the number of the degrees of similarities which are less than threshold value. Incidentally, because the second embodiment is same as the first embodiment with respect to the constitution of the talker recognition apparatus 100, the explanation about this constitution is omitted.

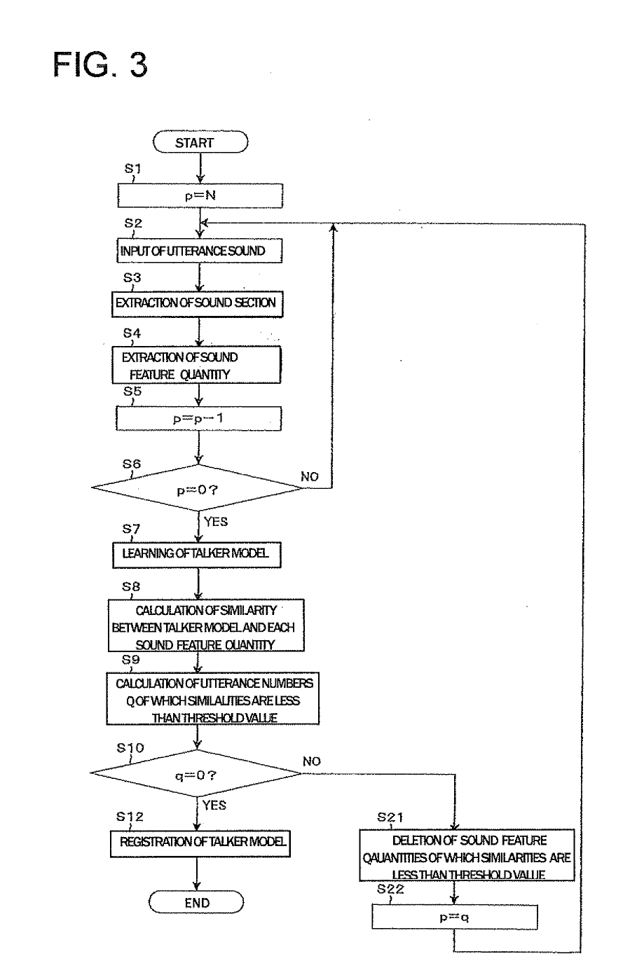

FIG. 3 is a flow chart which illustrates an example of the flow of a talker registration process of the talker recognition apparatus 100 according to the second embodiment. In this figure, as for the elements which are equivalent to those shown in FIG. 2, the same numeric symbols as those used in FIG. 1 are used, and detailed explanation about these elements are omitted.

As shown in FIG. 3, the processing of steps S1-S10 and S12 are same as those of the first embodiment.

Namely, utterance sounds of the N utterances are input, sound feature quantities which individually correspond to each input utterance sound are extracted, a talker model is generated using the extracted sound feature quantities of the N utterances, the degree of individual similarity between each extracted sound feature quantity of the N utterances and the generated talker model is calculated, and the criteria-unsatisfied utterance number q is calculated by making comparison between the calculated degree of each similarity and the threshold value. Then, in the case that the criteria-unsatisfied utterance number q is 0, the generated talker model is registered into the talker models' database.

When at least one of the degree of the similarity among the degrees of the similarities for the N utterances is less than the threshold value (Step S10:NO), the sound feature quantity extraction part 4 deletes only the sound feature quantities from which the similarities of being less than the threshold value are calculated, among sound feature quantities of the N utterances which are retained in the part 4 (Step S21). Namely, the sound feature quantity extraction part 4 deletes sound feature quantities by which the criteria-unsatisfied utterance number q is indicated, while the part 4 retains sound feature quantities from which the similarities of being equal to or more than the threshold value are calculated.

Next, the sound feature quantity extraction part 4 substitutes the criteria-unsatisfied utterance number of q into the counter p (Step S22), and the operation shifts to Step S2.

Thereafter, the processing of steps S2-S5 are repeated for the times indicated the criteria-unsatisfied utterance number of q. Thereby, the sound feature quantity extraction part 4 reserves the re-extracted sound feature quantities of the q utterances, which are extracted from the inputs of the new utterance sounds, in addition to the already reserved sound feature quantities of (N−q) utterances. Thus, the part 4 reserves the sound feature quantities of the N utterances in total.

Then, when the counter p becomes 0 (step S6:YES), the sound feature quantity extraction part 4 outputs the retained sound feature quantities for the N utterances to the talker model generation part 5 and also to the collation part 6. The talker model generation part 5 re-generates a talker model using these sound feature quantities for the N utterances (Step S7), the collation part 6 re-calculates the degree of individual similarity between each sound feature quantity of the N utterances and the talker model (Step S8).

Next, the similarity verifying part 9 calculates the number of the data each of which degree of similarity is less than the threshold value, as the criteria-unsatisfied utterance number q, by making comparison between the degree of each re-calculated similarity of the N utterances and the threshold value (Step S9). Then, the part 9 determines whether the criteria-unsatisfied utterance number q is 0 or not (step S10).

When the criteria-unsatisfied utterance number q is not 0, the operation shifts to Step S21. On the contrary, when the criteria-unsatisfied utterance number q is 0, the similarity verifying part 9 registers the re-generated talker model into the talker models' database (Step S12), and it is allowed to end the talker registration processing.

As described above, according to this embodiment, when at least one of the degree of the similarity among the degrees of the similarities for the N utterances is less than the threshold value and then the talker again utters the sounds of the q utterances, the utterance sounds of the q utterances, wherein the q is the number of being calculated as the number of the degrees of similarities which are less than threshold value, are re-input through the microphone 1, an individual sound feature quantity corresponding to each re-input utterance sound is re-extracted by the sound feature quantity extraction part 4, a talker model is re-generated by the talker model generation part 5 using both the sound feature quantities of the (N−q) utterances, from which the degree of similarities of being equal to or more than the threshold value were calculated, and the re-extracted sound feature quantities of the q utterances, the degree of individual similarity between each sound feature quantities of the (N−q) utterances or re-extracted sound feature quantity of the q utterances and the re-generated talker model is re-calculated by the collation part 6, and only in the case that all the re-calculated degrees of similarities of the N utterances are equal to or more than the threshold value, the re-generated talker model is registered in the talker models' database by the similarity verifying part 9. Thus, as compared with the first embodiment, it is possible to reduce the number of re-utterance times to be required when the talker model regarding the first N utterances can not be registered, and thus, it is possible to make the load of the talker reduce.

When utterance sounds which features are broadly distributed, the degree of similarity between the talker model generated using such utterance sounds and a utterance sound which is relatively correctly uttered is not always high as compared with the cases of other utterance sounds. Because, if the number of times of being incorrectly uttered becomes larger than the number of times of being correctly uttered, in the N times of utterances, it is impossible to say definitely that there is no possibility that the feature of the generated talker model becomes closer to the features of the incorrectly uttered sounds rather than the features of the correctly uttered sounds.

In such a situation, in the second embodiment, there is a possibility that sound feature quantities which show the features of the incorrectly uttered sounds remain retained. Thus, it is considered that the talker model can not be registered unless the sound is similarly uttered incorrectly thereafter. On the other hand, in the case of the first embodiment, such a troublesome situation can be evaded, because the N times of utterance is required again.

In other words, because it is not the fact that only either one is favorable absolutely in the first embodiment and the second embodiment, either one may be selected so as to be better profitable depending on the type of the system into which the talker recognition apparatus 100 is incorporated.

Incidentally, although the generated talker model is registered in the talker models' database when a condition that all the calculated degrees of the similarities of the N utterances are equal to or more than the threshold value in the above mentioned embodiments is satisfied, it is possible that the talker model is registered only in the case that the difference between the degree of the similarity which shows the maximum degree of similarity and the degree of the similarity which shows the minimum degree of the similarity among the degrees of similarities of the N utterances is not more than a prescribed value of the similarity degree's difference in addition to the above mentioned condition.

In other words, in such a case as the utterance sounds which features are broadly distributed and the talker model is generated using such utterance sounds, although the degree of similarity between the talker model thus generated and each individual utterance sounds becomes lower in general, the similarity is not always less than the threshold value (e.g., in the case that the influence of mixed noises is relatively small). However, in such a case, the similarity degree's differences among the extracted sound feature quantities of the N utterances becomes always broader. Therefore, by examining the similarity degree's difference, it becomes possible to register a talker model of having a higher recognition capability.

Incidentally, although the way of setting this difference of the degree of the similarity is optional, an optimum value of the difference may be found experimentally. For example, it may be practiced by collecting many samples, for both the sound feature quantities which are extracted when noises are mixed and the sound feature quantities which are extracted when the noise is not mixed, and then, finding the optimum value based on the distribution of differences of the degrees of similarities of these collected sound feature quantities.

Incidentally, in the above mentioned embodiments, a registered talker among two or more of the registered talkers is determined as the talker who uttered sound. However, when determining whether the talker who uttered sound is a single registered talker or not, it is possible to determine that the talker who uttered sound is the registered talker in the case that the calculated degree of the similarity is equal to or more than the threshold value, and to determine that the talker who uttered sound is not the registered talker in the case that the calculated degree of the similarity is less than the threshold value. Then, the result of such a determination can be output as a recognition result to the outside.

Further, in the above mentioned embodiments, both the processing of the registration of the talker models (talker registration) and the processing of the recognition of the talker are performed in one apparatus. However, it is also possible that the former processing is performed on a talker model registration dedicated apparatus and the latter processing is performed on a talker recognition dedicated apparatus. In such a case, the talker models' database may be constructed on the talker model recognition dedicated apparatus, while the both apparatuses are connected mutually via network or the like. Then, the talker model may be registered to the talker models' database via such a network from the talker model registration dedicated apparatus.

Furthermore, in the above mentioned embodiments, the processing of the talker registration, etc, are performed by the above mentioned talker recognition apparatus. However, it is also possible that the same processing of the talker registration, etc, as mentioned above is performed by equipping the talker recognition apparatus with a computer and a recording medium, storing program(s) which operates the above mentioned talker registration processing, etc., (an example of the acoustic model registration processing program) into the record medium, and loading the program(s) into the computer.

In this case, the recording medium as above mentioned may be composed of a recording medium such as DVD and CD, and the talker recognition apparatus may be equipped with a read-out apparatus capable of reading the program out from the recording medium.

In addition, this invention is not limited to the above mentioned embodiments. The above mentioned embodiments are disclosed only for the sake of exemplifying the present invention. Further, it should be note that every embodiment which has the substantially same constitution with the technical idea described in annexed claims and provides the substantially same functions and effects with the technical idea described in annexed claims is involved in the technical scope of the present invention regardless of its form.

1. An acoustic model registration apparatus, which comprises:
a sound inputting device through which utterance sound uttered by a talker is input;
a feature data generation device which generates a feature datum which shows acoustic feature of the utterance sound based on the input utterance sound;
a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device;
a similarity calculating device which calculates the degree of individual similarity between each feature datum in the prescribed utterance times and the generated acoustic model; and
a model memorizing control device which makes a model memorization device memorize the generated acoustic model as a registered model for talker recognition, only in a case where all the degrees of the similarities for the prescribed utterance times are equal to or more than a prescribed degree of the similarity, wherein the degrees of similarities are calculated by the similarity calculating device.

2. The acoustic model registration apparatus according to claim 1, which further comprises:
in a case where at least one of the degrees of the similarities for the prescribed utterance times are less than the prescribed degree of the similarity, wherein the degrees of similarities are calculated by the similarity calculating device;
the model generation device re-generates the acoustic model based on feature data of the prescribed utterance times, wherein the feature data are re-generated by the feature data generation device following re-input of the prescribed utterance times of utterance sounds trough the sound inputting device;
the similarity calculating device re-calculates the degree of individual similarity between each re-generated feature datum in the prescribed utterance times and the re-generated acoustic model; and
the model memorizing control device makes the model memorization device memorize the re-generated acoustic model as the registered model, only in a case where all the re-calculated degrees of the similarities for the prescribed utterance times are equal to or more than the prescribed degree of the similarity.

3. The acoustic model registration apparatus according to claim 1, which further comprises:
in a case where at least one of the degrees of the similarities for the prescribed utterance times are less than the prescribed degree of the similarity, wherein the degrees of similarities are calculated by the similarity calculating device;
the model generation device re-generates the acoustic model, based on feature data re-generated by the feature data generation device following re-input of utterance sounds for utterance times trough the sound inputting device, wherein the number of the utterance times are the number of times on which the degrees of similarities less than the prescribed threshold value are calculated, plus other feature data from which the degrees of similarities equal to or more than the prescribed degree of the similarity are calculated;
the similarity calculating device re-calculates the degree of individual similarity between each re-generated feature datum or feature datum from which the degree of similarity equal to or more than the prescribed degree of the similarity is calculated and the re-generated acoustic model; and
the model memorizing control device makes the model memorization device memorize the re-generated acoustic model as the registered model, only in a case where all the re-calculated degrees of the similarities for the prescribed utterance times are equal to or more than the prescribed degree of the similarity.

4. The acoustic model registration apparatus according to claim 1, wherein:
the model memorizing control device makes the model memorization device memorize the re-generated acoustic model as the registered model, only in a case where all the re-calculated degrees of the similarities for the prescribed utterance times are equal to or more than the prescribed degree of the similarity, and further the difference between the degree of the similarity which shows a maximum degree of similarity and the degree of the similarity which shows a minimum degree of the similarity among the degrees of similarities of the prescribed utterances is not more than a prescribed value of difference.

5. A talker recognition apparatus, which comprises:
a sound inputting device through which utterance sound uttered by a talker is input;
a feature data generation device which generates a feature datum which shows acoustic feature of the utterance sound based on the input utterance sound;
a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device;
a similarity calculating device which calculates the degree of individual similarity between each feature datum in the prescribed utterance times and the generated acoustic model;
a model memorizing control device which makes a model memorization device memorize the generated acoustic model as a registered model for talker recognition, only in a case where all the degrees of the similarities for the prescribed utterance times are equal to or more than a prescribed degree of the similarity, wherein the degrees of similarities are calculated by the similarity calculating device; and
a talker determination device which determines whether the uttered talker is a talker corresponding to the registered model or not, by comparing a feature datum with the memorized registered model, wherein the feature datum is generated by the feature data generation device when an utterance sound which is uttered for talker recognition is input through the utterance sound input device.

6. An acoustic model registration method using an acoustic model registration apparatus which is equipped with a sound inputting device through which utterance sound uttered by a talker is input, which comprises:
a feature data generation step in which a feature datum which shows acoustic feature of the utterance sound is generated based on the utterance sound which is input through the sound inputting device;
a model generation step in which an acoustic model which indicates acoustic feature of the utterance sound of the talker is generated based on feature data of a prescribed utterance times, wherein the feature data are generated by the feature data generation device in a case where the prescribed utterance times of utterance sounds are input by the sound inputting device;
a similarity calculating step in which the degree of individual similarity between each feature datum in the prescribed utterance times and the generated acoustic model is calculated; and
a model memorizing control step in which the generated acoustic model is memorized in a model memorization device as a registered model for talker recognition, only in a case where all the degrees of the similarities for the prescribed utterance times are equal to or more than a prescribed degree of the similarity, wherein the degrees of similarities are calculated by the similarity calculating device.

7. An acoustic model registration processing program, which comprises:
making a computer which is installed in an acoustic model registration apparatus, wherein the acoustic model registration apparatus is equipped with a sound inputting device through which utterance sound uttered by a talker is input, function as:
a sound inputting device through which utterance sound uttered by a talker is input;
a feature data generation device which generates a feature datum which shows acoustic feature of the utterance sound based on the input utterance sound; a model generation device which generates an acoustic model which indicates acoustic feature of the utterance sound of the talker based on feature data of a prescribed utterance times, wherein the feature data are generated by the feature data generation device in a case where the prescribed utterance times of utterance sounds are input by the sound inputting device;
a similarity calculating device which calculates the degree of individual similarity between each feature datum in the prescribed utterance times and the generated acoustic model; and
a model memorizing control device which makes a model memorization device memorize the generated acoustic model as a registered model for talker recognition, only in a case where all the degrees of the similarities of the prescribed utterance times are equal to or more than a prescribed degree of the similarity, wherein the degrees of similarities are calculated by the similarity calculating device.
